(19) United States
(12) Patent Application Publication
(10) Pub. No.: US 2025/0097760 A1
(43) Pub. Date: Mar. 20, 2025

(54) SYSTEMS AND METHODS FOR DEVICE-TO-DEVICE COMMUNICATIONS

(71) Applicant: ZTE CORPORATION, Shenzhen (CN)

(72) Inventors: Weiqiang DU, Shenzhen (CN); Wei LUO, Shenzhen (CN); Lin CHEN, Shenzhen (CN)

(73) Assignee: ZTE CORPORATION, Shenzhen (CN)

(21) Appl. No.: 18/899,100

(22) Filed: Sep. 27, 2024

Related U.S. Application Data
(63) Continuation of application No. PCT/CN2022/119458, filed on Sep. 16, 2022.

(51) Int. Cl. H04W 28/02; H04W 72/25

(52) U.S. Cl. CPC H04W 28/0268; H04W 72/25

(57) ABSTRACT

The present disclosure relates to receiving, by a first wireless communication device from a Network (e.g. Base Station (BS)), information indicating that the Network supports Sidelink (SL) Carrier Aggregation (CA). The first wireless communication device communicates with a second wireless communication device SL communications. The first wireless communication device reports to the Network, at least one of SL anomaly state on a first carrier or SL anomaly state recovery on the first carrier.

### CROSS-REFERENCE TO RELATED APPLICATION

This application claims the benefit of priority under 35 U.S.C. § 120 as a continuation of PCT Patent Application No. PCT/CN2022/119458, filed on Sep. 16, 2022, the disclosure of which is incorporated herein by reference in its entirety.

### TECHNICAL FIELD

The disclosure relates generally to wireless communications and, more particularly, to anomaly state in device-to-device communications.

### BACKGROUND

Sidelink (SL) communication refers to wireless radio communication between two or more User Equipments (UEs). In this type of communications, two or more UEs that are geographically proximate to each other can communicate without being routed to a Network (e.g. Base Station (BS)) or a core network. Data transmissions in SL communications are thus different from typical cellular network communications that include transmitting data to a Network and receiving data from a Network. In SL communications, data is transmitted directly from a source UE to a target UE through, for example the Unified Air Interface (e.g., PC5 interface) without passing through a Network.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

Some arrangements of the present disclosure relate to systems, methods, apparatuses, and non-transitory computer-readable media relating to receiving, by a first UE from a Network, information indicating that the Network supports SL Carrier Aggregation (CA). The first UE communicates with the second UE SL communications.

Some arrangements of the present disclosure relate to systems, methods, apparatuses, and non-transitory computer-readable media relating to communicating, by a first UE with a second UE, SL communications. The first UE reports to a Network at least one frequency used in the SL communications with the second UE based on a Quality of Service (QOS) flow.

Some arrangements of the present disclosure relate to systems, methods, apparatuses, and non-transitory computer-readable media relating to receiving, by a Network from a first UE, information indicating that the Network supports SL CA. The first UE communicates with a second UE SL communications. The Network receives from the first UE report of at least one of anomaly state on a first carrier or anomaly state recovery on the first carrier.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication network, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communication, according to various arrangements.

FIG. 3 is a flowchart diagram illustrating an example method for managing CA-based SL wireless communications, according to various arrangements.

FIG. 4 is a flowchart diagram illustrating an example method for managing CA-based SL wireless communications, according to various arrangements.

FIG. 5 is a flowchart diagram illustrating an example method for managing CA-based SL wireless communications, according to various arrangements.

FIG. 6 is a flowchart diagram illustrating an example method for managing SL wireless communications, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional network-centric cellular networks have limited high data rate capabilities and support for proximity services. In this context, device-to-device (D2D) communications emerge to address the shortcomings of the network-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

To improve the reliability, data rate, latency of SL communications, Carrier Aggregation (CA) can be implemented for SL communications. In CA, two or more Component Carriers (CCs) are aggregated in order to support wider transmission bandwidths in the frequency domain. In some examples, a vehicle UE can simultaneously perform SL reception and transmission on one or multiple CCs. The arrangements disclosed herein relate to data split and data duplication based on CA.

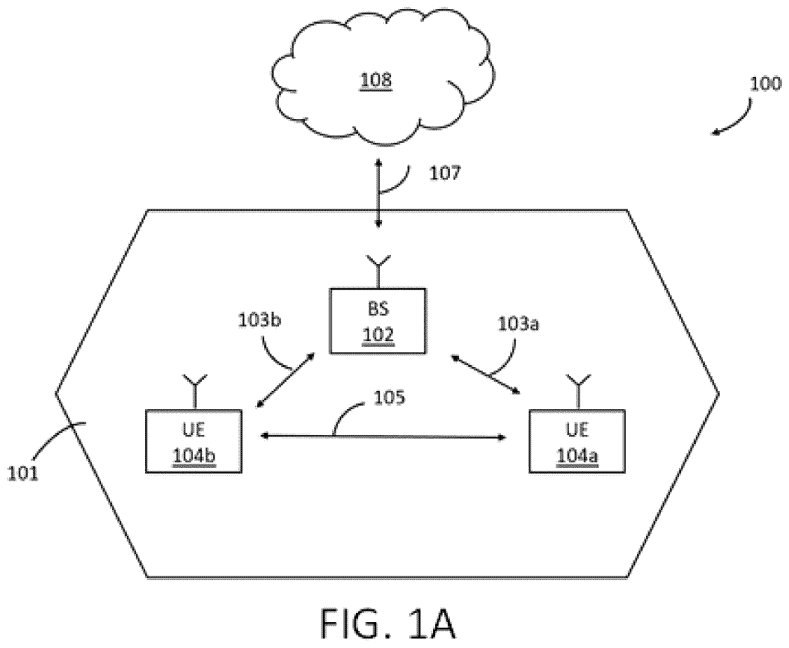

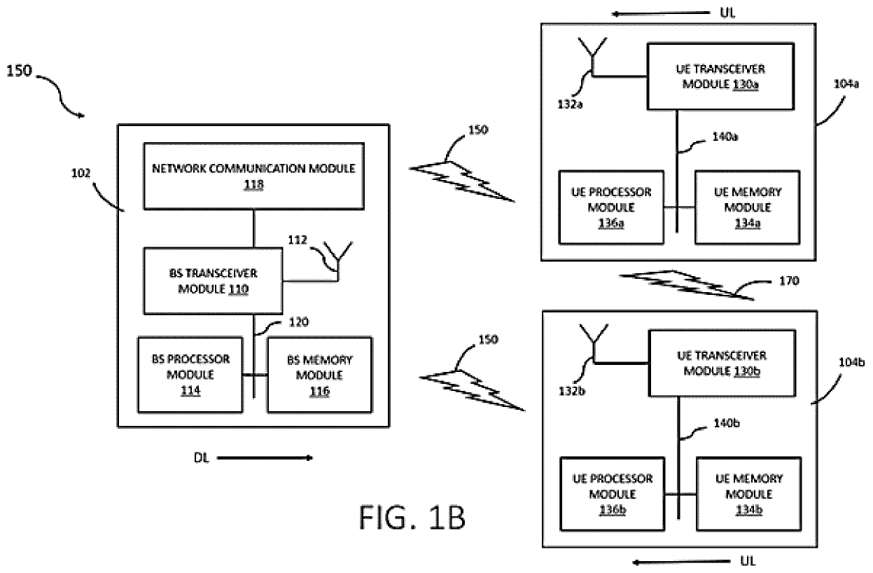

Referring to FIG. 1A, an example wireless communication network 100 is shown. The wireless communication network 100 illustrates a group communication within a cellular network. In a wireless communication system, a network side communication node or a Network can include a next Generation Node B (gNB), an E-UTRAN Node B (also known as Evolved Node B, eNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In FIG. 1A, a network side and a terminal side communication node are represented by a Network 102 and UEs 104a and 104b, respectively. In some arrangements, the Network 102 and UEs 104a/104b are sometimes referred to as “wireless communication node” and “wireless communication device,” respectively. Such communication nodes/devices can perform wireless communications.

In the illustrated arrangement of FIG. 1A, the Network 102 can define a cell 101 in which the UEs 104a and 104b are located. The UEs 104a and/or 104b can be moving or remain stationary within a coverage of the cell 101. The UE 104a can communicate with the Network 102 via a communication channel 103a. Similarly, the UE 104b can communicate with the Network 102 via a communication channel 103b. In addition, the UEs 104a and 104b can communicate with each other via a communication channel 105. The communication channels 103a and 104b between a respective UE and the Network can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The Network 102 is connected to Core Network (CN) 108 through an external interface 107, e.g., an Iu interface.

In some examples, a remote UE (e.g., the UE 104b) that does not directly communicate with the Network 102 or the CN 108 (e.g., the communication channel link 103b is not established) communicates indirectly with the Network 102 and the CN 108 using the SL communication channel 105 via a relay UE (e.g., the UE 104a), which can directly communicate with the Network 102 and the CN 108 or indirectly communicate with the Network 102 and the CN 108 via another relay UE that can directly communicate with the Network 102 and the CN 108.

FIG. 1B illustrates a block diagram of an example wireless communication system for transmitting and receiving downlink, uplink and SL communication signals, in accordance with some arrangements of the present disclosure. In some arrangements, the system can transmit and receive data in a wireless communication environment such as the wireless communication network 100 of FIG. 1A, as described above.

The system generally includes the Network 102 and UEs 104a and 104b, as described in FIG. 1A. The Network 102 includes a Network transceiver module 110, a Network antenna 112, a Network memory module 116, a Network processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The Network 102 communicates with the UEs 104a and 104b via one or more of a communication channel 150, which can be any wireless channel or other medium known in the art suitable for transmission of data as described herein.

The system may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the Network 102 is known as an uplink transmission, and a wireless transmission from an antenna of the Network 102 to an antenna of one of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the Network transceiver module 110 may be herein referred to as a downlink transceiver, or Network transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the Network 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the Network transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the Network transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the Network transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the Network 102 that enable bi-directional communication between Network transceiver 110 and other network components and communication nodes configured to communication with the Network 102. For example, the network interface 118 may be configured to support internet or WiMAX traffic. In a typical deployment, without limitation, the network interface 118 provides an 802.3 Ethernet interface such that Network transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the Network 102 to communicate with other Network s or core network over a wired or wireless connection.

In some arrangements, each of the UEs 104a and 104b can operate in a hybrid communication network in which the UE communicates with the Network 102, and with other UEs, e.g., between 104a and 104b. As described in further detail below, the UEs 104a and 104b support SL communications with other UE's as well as downlink/uplink communications between the Network 102 and the UEs 104a and 104b. In general, the SL communication allows the UEs 104a and 104b to establish a direct communication link with each other, or with other UEs from different cells, without requiring the Network 102 to relay data between UEs.

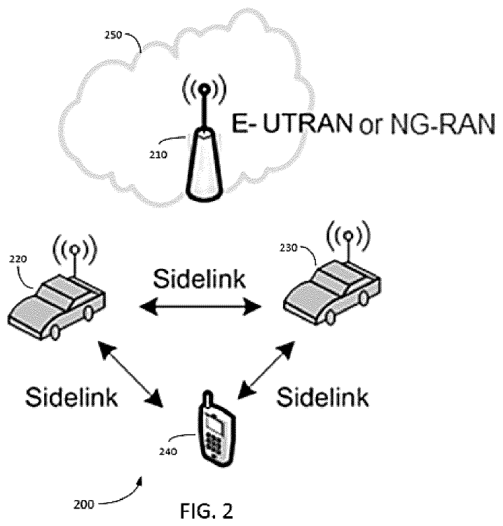

FIG. 2 is a diagram illustrating an example system 200 for SL communication, according to various arrangements. As shown in FIG. 2, a Network 210 (such as Network 102 of FIG. 1A) broadcasts a signal that is received by a first UE 220, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the base station 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX) UE, and the UE that is receiving said data is referred to as the reception (RX) UE.

In some examples, a Network may not support SL CA. For example, a Network may not be able to schedule SL resources on multiple carrier or cannot provide SL configurations for multiple carriers. Some arrangements disclosed herein relate to the UE determining whether a Network supports SL CA.

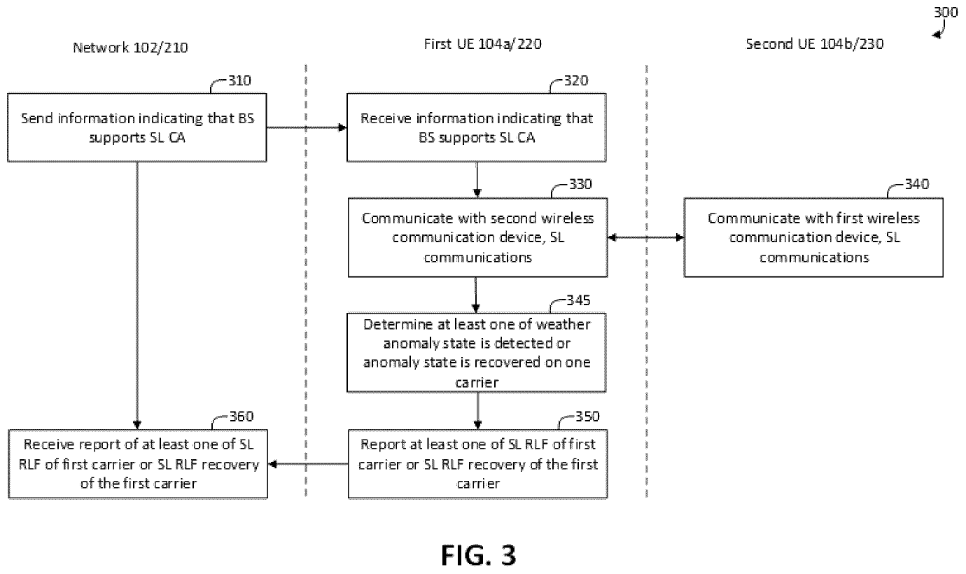

FIG. 3 is a flowchart diagram illustrating an example method 300 for managing CA-based SL wireless communications, according to various arrangements. Referring to FIGS. 1A-3, the method 300 can be performed by a first UE (e.g., the UE 104a/220), a second UE (e.g., the UE 104b/230), and a Network 102/210. Communication via the SL wireless communication channel 170 or SL network is shown as cross the dashed line between the first UE and the second UE. Communication via wireless communication channel 103a/150 is shown as cross the dashed line between the first UE and the Network.

At 310, the Network sends information indicating that the Network supports SL CA. At 320, the UE receives information indicating that Network supports SL CA. In response to the UE receiving such information, the UE can determine that Network support SL CA. In some examples, the first UE determines that the Network supports SL CA in response to determining that the information includes an indication on Network supports SL CA. In some examples, the information indicating that Network supports SL CA includes System Information Block (SIB). In response to determining that the information contains configurations for two or more SL carriers, the first UE determines that the Network supports the SL CA For example, in response to receiving a SIB with configurations for two or more SL carriers, the first UE can determine that the Network supports SL CA. In some examples, the information indicating that Network supports SL CA can include other information, message, or signaling, such as Radio Resource Control (RRC) signaling, Media Access Control (MAC) Control Element (CE), and so on that indicates explicitly that SL CA is supported by the Network.

At 330, the first UE communicates with the second UE SL communications. At 340, the second UE communicates with the first UE SL communications. For example, the first UE and the second UE are sending and receiving signals and data to each.

At 345, the first UE determine at least one of whether the anomaly state is detected or anomaly state is recovered on one carrier.

At 350, the first UE reports to the Network at least one of SL anomaly state on the first carrier or SL anomaly state recovery on the first carrier, in response to the first wireless communication device determining that the Network supports the SL CA.

At 360, the Network receives from the first UE report of the at least one of the SL anomaly state on the first carrier or the SL anomaly state recovery on the first carrier. Accordingly, in the example in which two or more SL carriers are included in the SIB, the first UE reports SL carrier anomaly state to the Network. In some arrangements, the first UE report the at least one of the SL anomaly state on the first carrier or the SL anomaly state recovery on the first carrier, in response to the first UE determining that Network supports SL CA.

In some arrangements, the anomaly state includes Radio Link Failure. In some examples, a UE such as the first UE can detect the anomaly state for a carrier in the manner described herein, and as a response triggers RLF on that carrier directly. In some examples, in response to detecting the anomaly state as described, the first UE can trigger the RLF for the carrier upon determining that the first UE cannot recover from the anomaly state for the carrier.

In some arrangements, the first UE determines the anomaly state on the first carrier in response to detecting an amount of absent feedback information on the first carrier reaches a maximum value (e.g., a predetermined threshold). The absent feedback information includes at least one of absent Physical Sidelink Feedback Channel (PSFCH) reception or absent Hybrid Automatic Repeat Request (HARQ) feedback reception. In some arrangements, the maximum value can be configured by at least one of the network (e.g. the Network), a second UE, or so on.

For example, the first UE determines the anomaly state on the first carrier in response to detecting a number of absent PSFCH reception on at least one PSFCH reception resource (e.g., occasion) for the first carrier reaches a maximum absent PSFCH reception threshold. That is, the first UE detects that the anomaly state has occurred on the first carrier in response to determining that the maximum number of absent PSFCH reception on at least one PSFCH reception resource for the first carrier in communicating with the second UE via the SL connection has been reached. For example, the first UE determines the anomaly state on the first carrier in response to determining a number of absent HARQ feedback on at least one HARQ feedback resource (e.g., occasion) for the first carrier reaches a maximum absent HARQ feedback threshold. That is, the first UE detects that the anomaly state has occurred on the first carrier in response to determining that the maximum number of absent HARQ feedback on the HARQ feedback resource for the first carrier in communicating with the second UE via the SL connection has been reached. For example, the first UE determines the anomaly state on the first carrier in response to determining that positive-negative acknowledgement is selected and that the number of absent PSFCH reception on at least one PSFCH reception resource for the first carrier reaches the maximum absent PSFCH reception threshold. That is, the first UE detects that the anomaly state has occurred on the first carrier in response to determining that the maximum number of absent PSFCH reception is absent on the PSFCH reception resource for the first carrier in communicating with the second UE via the SL connection has been reached, where the positive-negative acknowledgement is selected, e.g., by at least one of the first UE, the second UE, or the Network. For example, the first UE determines the anomaly state on the first carrier in response to determining that negative-only acknowledgement is selected and that the number of absent PSFCH reception on at least one PSFCH reception resource for the first carrier reaches the maximum absent PSFCH reception threshold. That is, the first UE detects that the anomaly state has occurred on the first carrier in response to determining that the maximum number of absent PSFCH reception is absent on the PSFCH reception resource for the first carrier in communicating with the second UE via the SL connection has been reached, where the negative-only acknowledgement is selected, e.g., by at least one of the first UE, the second UE, or the Network.

In some arrangements, the first UE determines the anomaly state on the first carrier in response to determining that a ratio of an amount of absent feedback information on the first carrier to an amount of intended feedback information on the first carrier reaches a maximum value (e.g., a predetermined threshold). The ratio can include at least one of a ratio of a number of absent PSFCH receptions on at least one PSFCH reception resource for the first carrier to a number of intended PSFCH receptions on the at least one PSFCH reception resource, or a ratio of a number of absent HARQ feedback on at least one HARQ feedback resource for the first carrier to the number of intended HARQ feedback on the at least one HARQ feedback resource.

For example, the first UE detects that the anomaly state has occurred on the first carrier in response to determining that a ratio of a number of absent PSFCH receptions on at least one PSFCH reception resource for the first carrier to the number of intended PSFCH receptions on the at least one PSFCH reception resource reaches a PSFCH ratio threshold, and positive-negative acknowledgement is selected. That is, the first UE detects that the anomaly state has occurred on the first carrier in response to determining that the ratio of number of absent PSFCH reception on the first carrier to the number of intended PSFCH receptions on the first carrier reaches a threshold, where positive-negative acknowledgement is selected. For groupcast and in the example in which positive-negative acknowledgement is used, each RX UE (e.g., the first UE) sends the HARQ feedback on different PSFCH resources (e.g., the at least one PSFCH reception resource). For a given transmission, TX UE (e.g., the second UE) is intended to receive N PSFCH receptions (intended HARQ feedback) on N PSFCH resources, where N is the group size. The group size is the number of RX UEs within the group.

For example, the first UE detects that the anomaly state has occurred on the first carrier in response to determining that a ratio of a number of absent HARQ feedback on at least one HARQ feedback resource for the first carrier to the number of intended HARQ feedback on the at least one HARQ feedback resource reaches a HARQ feedback ratio threshold, and positive-negative acknowledgement is selected. That is, the first UE detects that the anomaly state has occurred on the first carrier in response to determining that the ratio of number of absent HARQ feedback to the number of intended HARQ feedback is higher than a threshold, where positive-negative acknowledgement is selected. For groupcast and in the example in which positive-negative acknowledgement is used, each RX UE (e.g., the first UE) sends the HARQ feedback on different PSFCH resources (e.g., the at least one HARQ feedback resource). For a given transmission, TX UE (e.g., the second UE) is intended to receive N PSFCH receptions (intended HARQ feedback) on N HARQ feedback resources, where Nis the group size. The group size is the number of RX UEs within the group.

For example, the first UE detects that the anomaly state has occurred on the first carrier in response to determining that a ratio that assess business of the channel on the first carrier exceeds a threshold. For example, the first UE can detect that a Channel Busy Ratio (CBR) of a resource pool on the first carrier is higher than a configured threshold, where the CBR indicates the channel congestion (e.g., the greater the CBR, the greater the channel congestion). The CBR can include a ratio of sub-channels with signal strength (e.g., measured using Received Signal Strength Indicator (RSSI) higher than a threshold to a total number of sub-channels on the carrier. The first UE can determine the CBR on the first carrier.

For example, the first UE detects that the anomaly state has occurred on the first carrier in response to determining a number of retransmissions for a destination reaches a retransmission maximum value. For example, the SL Radio Link Control (RLC) entity residing in at least one of the Network, the first UE, or the second UE can indicate to the first UE that the maximum number of retransmissions for a specific destination has been reached.

For example, the first UE detects that the anomaly state has occurred on the first carrier in response to determining that a RRC reconfiguration timer (e.g., T400) for the destination has expired. The timer T400 is initiated in response to transmission of RRC reconfiguration message for SL and stopped in response to receiving an RRC reconfiguration failure message for SL or RRC reconfiguration complete message for SL.

For example, the first UE detects that the anomaly state has occurred on the first carrier in response to determining that a number of consecutive HARQ Discontinuous Transmission (DTX) for a destination reaches a HARQ DTX maximum value. The Media Access Control (MAC) entity residing in at least one of the Network, the first UE, or the second UE can indicate to the first UE the maximum number of consecutive HARQ DTX on the first carrier for a destination has been reached.

For example, the first UE detects that the anomaly state has occurred on the first carrier in response to determining that integrity for at least one Signaling Radio Bearer (SRB) (e.g., SL-Signaling Radio Bearer 2 (SL-SRB2) or SL-SRB3) for a destination has failed. A SL Packet Data Convergence Protocol (PDCP) entity residing on one or more of the first UE, the second UE, and the Network can send to the first UE an integrity check failure indication indicating integrity failing of at least one of SL-SRB2 or SL-SRB3 for a destination.

For example, the first UE determines that the anomaly state on the first carrier has been recovered in response to receiving an indication corresponding to recovering the anomaly state. In some examples, receiving the indication comprises at least one of receiving, by the first UE from a network (e.g., the Network), a SL carrier list including this first carrier, receiving, by the first UE from a network (e.g., the Network), a first activation indication indicating activating the first carrier, receiving, by the first UE from the network, a first recovery indication indicating recovering the first carrier, receiving, by the first UE from a peer UE (e.g., the second UE), a second activation indication indicating activating the first carrier, or receiving, by the first UE from the second UE, a second recovery indication indicating recovering the first carrier.

For example, the first UE determines that the anomaly state on the first carrier has been recovered in response to the first UE determining that a timer initiated responsive to determining the anomaly state on the first carrier has expired. For example, the first UE starts a timer upon anomaly state is detected on the first carrier, and in response to determining that the timer expired, the first UE considers the first carrier is recovered from anomaly state.

In some examples, in response to the first UE detecting anomaly state on the first carrier, the first UE transmits an anomaly state recovery signaling to a peer UE (e.g., the second UE). After receiving the anomaly state recovery response signaling from the peer UE, the first UE determines that the anomaly state for the first carrier has been recovered. In some examples, the response signaling can include HARQ feedback. Thus, in some arrangements, in response to determining the anomaly state on the first carrier, the first UE transmits at least one anomaly state recovery signaling to the second UE. The first UE receives from the second UE at least one anomaly state response signaling. The first UE determines that the anomaly state on the first carrier has been recovered in response to receiving the at least one anomaly state response signaling.

For example, the recovery signaling can be a RRC signaling. For example, the recovery signaling can be a MAC CE.

For example, the response signaling can be a RRC signaling. For example, the recovery signaling can be a MAC CE. For example, the recovery signaling can be a HARQ feedback. For example, the response signaling can be a RRC re-establishment signaling.

In some examples, in response to the first UE detecting anomaly state on the first carrier, the first UE starts a recovery procedure, the recovery procedure is transmitting a first number (e.g., N) of anomaly state recovery signaling to a peer UE (e.g., the second UE). After receiving at least a second number (e.g., M) of anomaly state recovery response signaling from the peer UE, the first UE determines that the anomaly state for the first carrier has been recovered. In response to the first UE receiving a third number of anomaly state response signaling, the third number is less than a second number, the first UE determines at least one of: anomaly state recovery cannot be recovered or RLF is to be detected on this carrier. In some examples, the response signaling can include HARQ feedback. The first number N and the second number M can be integers received from the network (e.g., the Network) or is predetermined. Thus, in some arrangements, in response to determining the anomaly state on the first carrier, the first UE transmits a first number (e.g., N) of at least one anomaly state recovery signaling to the second UE. The first UE receives from the second UE a second number at least one anomaly state response signaling. The second number reaches a threshold (e.g., M). The first UE determines that the anomaly state on the first carrier has been recovered in response to receiving the second number of the at least one anomaly state response signaling. If the first UE does not receive from the second UE a second number of the at least one anomaly state response signaling failing to reach the threshold M, the first UE considers the carrier cannot be recovered from anomaly state.

In some arrangements, the first UE transmits a first number (e.g., N) of at least one anomaly state recovery signaling to the second UE with a first period (e.g., K millisecond). In some arrangements, the transmission period can be controlled by a timer, for example, in response to the recovery procedure being triggered, the first UE starts a timer. In response to determining that the first timer has expired, the first UE transmits the recovery signaling and re-start the first timer. In response to determining that the maximum transmission number of recovery signaling has been reached, the first UE stops the first timer.

In some arrangements, in response to the recovery procedure being triggered, the first UE starts a timer. In response to determining that the first timer has expired and that the second number of received response signaling is less than a threshold (e.g., a maximum number), the first UE determines that RLF is to be detected on this carrier.

In some arrangements, in response to the recovery procedure being triggered, the first UE starts a timer. In response to determining that the first timer has expired and that the second number of received response signaling is less than a threshold (e.g., the maximum number), the first UE determines that this carrier is not recovered.

In some arrangements, the first UE receives from the network (e.g., the Network) at least one of the value of first number for recovery signaling, the value of second number for response signaling, the value of first period for recovery signaling, the value of first timer for transmission of recovery signaling, the priority of recovery signaling, the priority of response signaling, the latency bound of recovery signaling, the HARQ feedback attribute (e.g., HARQ enable or disable) of recovery signaling, the maximum retransmission number of recovery signaling, the latency bound of response signaling, the HARQ feedback attribute (e.g., HARQ enable or disable) of response signaling, the maximum retransmission number of response signaling, and so on.

In some examples, in response to determining that the anomaly state for the first carrier is recovered, the first UE reports anomaly state recovery on the first carrier to the network (e.g., the Network). In some examples, the first UE starts a timer upon anomaly state is detected on the first carrier, and in response to determining that the timer expired, the first UE determines the anomaly state with respect to the destination (e.g., the second UE). In response to determining that no carrier meets a carrier selection condition (e.g., no carrier can be selected or reselected) for communicating with a destination (e.g., the second UE), the first UE determines the anomaly state at the destination.

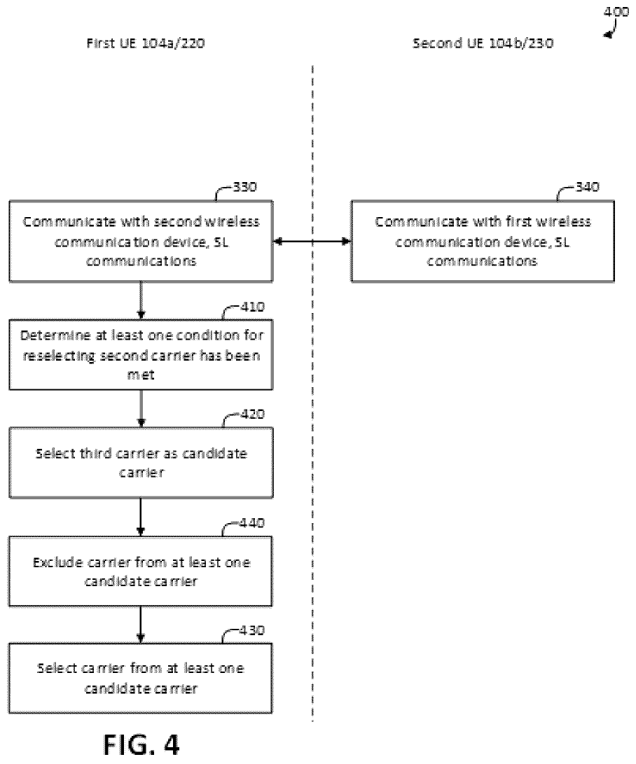

FIG. 4 is a flowchart diagram illustrating an example method 400 for managing CA-based SL wireless communications, according to various arrangements. Referring to FIGS. 1A-4, the method 400 can be performed by a first UE (e.g., the UE 104a/220), a second UE (e.g., the UE 104b/230), and the network 102/210. Communication via the SL wireless communication channel 170 or SL network is shown as cross the dashed line between the first UE and the second UE.

At 330, as described, the first UE communicates with the second UE SL communications. At 340, as described, the second UE communicates with the first UE SL communications.

At 410, the first UE determines that at least one condition for triggering reselection a carrier (e.g., the second carrier) has been met. The first UE can determine that at least one condition for triggering the reselection procedure has been met. In response to determining that the at least one condition for triggering the carrier reselection procedure has been met, the first UE triggers the carrier reselection procedure. The carrier reselection procedure includes selecting, by the first UE, at least one candidate carrier and selecting a carrier among the at least one candidate carrier.

For example, the first UE can trigger carrier selection or reselection of the second carrier in response to determining at the at least one condition for triggering reselection. Examples of a condition for triggering reselection include anomaly state is detected on the second carrier, anomaly state is detected on the destination, selected carrier (e.g., the second carrier) for a destination is included in a non-preferred carrier list provided by a peer UE (e.g., the second UE), selected carrier (e.g., the second carrier) for a destination is included in a disallowed carrier list provided by peer UE (e.g., the second UE), upon receiving indication from sidelink RLC entity that the maximum number of retransmissions for a specific destination has been reached, upon receiving RRC reconfiguration timer (e.g., T400) has expired for a specific destination, upon receiving indication from MAC entity that the maximum number of consecutive HARQ DTX for a specific destination has been reached, or upon receiving integrity check failure indication from SL PDCP entity concerning SL RB (e.g. SL-SRB2 or SL-SRB3) for a specific destination.

At 420, the third carrier is selected as candidate carrier. In some examples, the first UE selects a carrier (e.g., the third carrier) that is included in a preferred carrier list provided by peer UE (e.g., the second UE) as candidate carrier. That is, in the example in which there are carriers in the preferred carrier list provided by the peer UE, the first UE selects the carrier indicated in the preferred carrier list as the third carrier.

In some examples, the first UE selects the third carrier that satisfies at least one condition for selecting a candidate carrier for SL communication with the second UE as candidate carrier. Examples of a condition for selecting a candidate carrier include at least one of no anomaly state is detected on the third carrier, channel congestion (e.g., as measured by CBR) of the third carrier is lower than a configured or predetermined threshold, the third carrier is not included from a disallowed carrier list provided by peer UE (e.g., the second UE), or the third carrier is not included from a non-preferred carrier list provided by peer UE (e.g., the second UE).

In some arrangements, the first UE determines that a carrier (e.g., the third carrier) to be a candidate carrier for selection or reselection in response to determining that at least one condition for candidate carrier is met. Examples of a condition for candidate carrier include no anomaly state is detected on the third carrier, channel congestion (e.g., as measured by CBR) of the third carrier is lower than a configured or predetermined threshold, the third carrier is not included from a disallowed carrier list provided by peer UE (e.g., the second UE), or the third carrier is not included from a non-preferred carrier list provided by peer UE (e.g., the second UE).

At 430, the first UE selects the carrier from at least one candidate carrier. In some examples, one carrier (e.g., the third carrier) among the candidate carriers is selected in response to determining that the carrier is included in a preferred carrier list provided by peer UE (e.g., the second UE). In some examples, one carrier (e.g., the third carrier) among the candidate carriers is selected in response to determining that the carrier is not included in at least one of non-preferred carrier list or dis-allowed carrier list provided by peer UE (e.g., the second UE). In some examples, in response to determining that no candidate carrier is included in a preferred carrier list provided by peer UE, the UE randomly selects a carrier among the at least one candidate carrier. In some examples, in response to determining that all of the at least one candidate carrier is included in at least one of a non-preferred carrier list or a dis-allowed carrier list provided by peer UE, the UE randomly selects a carrier among the at least one candidate carriers. In some example, candidate carrier included in a preferred carrier are selected first, by the first UE.

At 440, the first UE excludes the carrier from the at least one candidate carrier. In some examples, the carrier is excluded from the at least one candidate carrier if at least one condition is met. Examples of the condition for excluding the carrier from the at least one candidate carrier include at least one of: anomaly state is detected on the third carrier by the UE, channel congestion (e.g., as measured by CBR) of the third carrier is higher than a configured or predetermined threshold, the third carrier is included from a disallowed carrier list provided by peer UE (e.g., the second UE), or the third carrier is included from a non-preferred carrier list provided by peer UE (e.g., the second UE), or the anomaly state is detected on the third carrier.

In some arrangements, data for each service type can be mapped to one or more frequencies or frequency ranges. Service types associated with different radio frequencies or frequency ranges can be classified into distinct Quality of Service (QOS) flows such as PC5 QoS flows. A QoS flow can be defined by QoS parameters and QoS characteristics, referred to as QoS profiles. In other words, different QoS flows can be associated with different frequencies or frequency ranges. Examples of service types include Multimedia Priority Service (MPS), evolved Multimedia Broadcast Multicast Service (eMBMS), Further eMBMS (FeMBMS) and so on. For a UE (e.g., the first UE) performing SL communication (e.g., at 330), the UE reports to the Network the corresponding SL frequency (e.g., at least one frequency or frequency range) and QoS flow for requesting configurations, resources, and so on. In some examples in which two or more services have the same destination layer 2 ID, reporting the SL frequency to the Network in granularity of destination layer2 ID leads to the Network failing to differentiate whether reported SL frequency can be used for all services with same destination layer 2 ID. In some arrangements, the UE reports the SL frequency in granularity of QoS flow (e.g., PC5 QoS flow) to the Network. In some arrangements, the UE reports the QoS flow in granularity of sidelink frequency to the Network. In some arrangements, the UE reports to the Network the mapping of QoS flow to SL frequency.

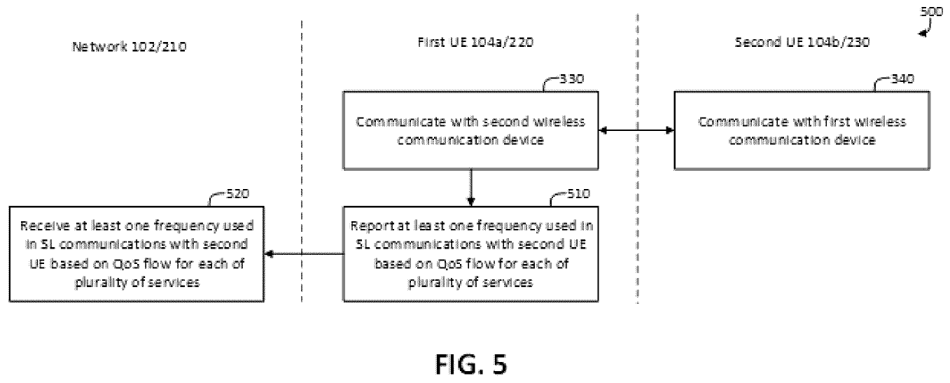

FIG. 5 is a flowchart diagram illustrating an example method 500 for managing CA-based SL wireless communications, according to various arrangements. Referring to FIGS. 1A-5, the method 500 can be performed by a first UE (e.g., the UE 104a/220), a second UE (e.g., the UE 104b/230), and a Network 102/210. Communication via the SL wireless communication channel 170 or SL network is shown as cross the dashed line between the first UE and the second UE. Communication via wireless communication channel 103a/150 is shown as cross the dashed line between the first UE and the Network.

At 330, as described, the first UE communicates with the second UE SL communications. At 340, as described, the second UE communicates with the first UE SL communications.

At 510, the first UE reports to the Network at least one frequency (e.g., at least one frequency range) used in the SL communications with the second UE based on a QoS flow. At 520, the Network receives from the first UE the at least one frequency used in the SL communications with the second UE based on a QoS flow.

In some examples, reporting the at least one frequency used in the SL communications with the second UE based on the QoS flow includes reporting, by the first UE to the Network, the at least one frequency for the QoS flow for each of a plurality of destination of the SL communications. In other words, for each of the at least one frequency used in the SL communications with the second UE, the first UE report a QoS flow associated with the reported at least one frequency. For example, the first UE reports, for each of the reported at least one frequency, a frequency (or frequency range) for the SL communications, a QoS flow associated with the frequency for the SL communications.

In some examples, reporting the at least one frequency used in the SL communications with the second UE based on the QoS flow includes reporting the QoS flow for each of a plurality of services of the SL communications for each of the at least one frequency. In other words, for each of the QoS flow, the first UE reports the SL frequency associated with the reported QoS flow. For example, the first UE reports to the Network the QoS flow (e.g., a QoS flow identifier and/or other attributes) and at least one frequency (or frequency range) for the SL communication associated with the QoS flow.

In some examples, reporting the at least one frequency used in the SL communications with the second UE based on the QoS flow includes reporting a mapping that maps the at least one frequency to the QoS flow for each of a plurality of services of the SL communications.

In some arrangements, the first UE passes the at least one frequency from a higher layer (e.g., a V2X layer) to a lower layer for performing the SL communications in granularity of each QoS flow. In some arrangements, the first UE passes the QoS flow and the at least one frequency associated with the QoS flow to lower layer for performing the SL communications in granularity of each QoS flow. In some arrangements, the first UE passes the at least one frequency and PC5 QoS flow associated to the SL frequency to the lower layer for performing the SL communications in granularity of each QoS flow.

In some arrangements, different service types can have a same destination layer 2 ID, and the service types have different radio frequencies and are classified into same QoS Flows. In this case, the first UE passes only the overlapping frequencies (e.g., at least one overlapping frequency range) of the different services from the higher layer (e.g., the V2X layer) to the lower layer. That is, each of the at least one frequency passed to the lower layer is an overlapping frequency between two or more of the plurality of services of the SL communications. In the example in which there is no overlapping frequencies for the service types, the services types are not be classified into same QoS flow. In other words, the first UE ensures that the frequencies classified into the same PC5 QoS flow can be used by all service types mapped into this PC5 QOS flow. For example, the first UE initiate SL communications with the second UE (e.g., at 330) for a first service and a second service. The first service is mapped to (e.g., can be communicated using) a first frequency (e.g., a first frequency range) and a second frequency (e.g., a second frequency range). The second service is mapped to (e.g., can be communicated using) the second frequency and a third frequency. The first UE determine that first service and second service can use same PC5 QoS flow (e.g., a first QoS flow). In this case, for the first UE that is passing the first QoS flow to the lower layer, only the second frequency that is associated the first QoS flow is passed into lower layer.

In some examples, the first UE passes from a higher layer (e.g., V2X layer) to a lower layer, at least one frequency for each of at least one service type, the at least one service type for each of the at least one frequency, the at least one service type and the at least one frequency associated with the at least one service type, or the at least one frequency and the at least one service type associated with the at least one frequency. That is, the first UE passes at least one of following from the higher layer (V2X) layer to the lower layer, the sidelink frequency (or frequency range) in granularity of the service type, the service type in granularity of sidelink frequency, the service type and associated sidelink frequency, or the sidelink frequency and associated service type.

In some arrangements, for the first UE reporting the SL frequency to the Network, only the overlapping frequencies (e.g., at least one overlapping frequency range) used by all service types associated to the same destination identifier (e.g., destination L2 ID) are reported. In some examples, the destination identifier identifies the second UE. For example, the first UE initiate SL communications with the second UE (e.g., at 330) for a first service and a second service. The first service is mapped to (e.g., can be communicated using) a first frequency (e.g., a first frequency range) and a second frequency (e.g., a second frequency range). The second service is mapped to (e.g., can be communicated using) the second frequency and a third frequency. The first UE determines that the first service and the second service can use the same destination L2 ID-1. In this case, when the first UE reports the at least one frequencies to the Network, only the second frequency is reported for this destination L2 ID-1.

In some arrangements, for SL relay communications, a remote UE connects with a Network via a relay UE, where the remote UE communicates with the relay UE via SL communication. For a UE performing SL communication, the UE selects a synchronization reference source. Examples of the source include Global Navigation Satellite System (GNSS), cell, or UE. A remote UE that is not in coverage of a cell cannot select the cell as reference source. However, it is possible that based on the configuration (e.g., sync priority in SIB12 or RRC reconfiguration is set to Network), the remote UE shall select the cell as a reference.

In some arrangements, the remote UE is not allowed to request the SIB12 via the relay UE.

In some examples, message-A includes at least one of RRC message or SIB message.

In some examples, source-A can be at least one of the network, the Network, a primary cell, a serving cell, one frequency (e.g., a frequency range), GNSS, user equipment, or so on.

In some arrangements, for the frequency used to transmit NR SL communication, in response to the UE determining that the UE is in coverage of a first source (e.g., the source-A), the UE can select source-A as a reference.

For the frequency used to transmit NR SL communication, if the frequency concerns (e.g., is related to, is associated with, is used by or for) source-A, and if UE determines or considers that it is in coverage of source-A, the UE can select source-A as reference.

For the frequency used to transmit NR sidelink communication, if the frequency concerns the source-A, and if UE determines or considers that it is in coverage of source-A, the UE can select the downlink frequency paired with source-A as reference.

For the frequency used to transmit NR SL communication, if the UE is out of coverage on the concerned frequency, and if UE determines or considers that it is in coverage of source-A, the UE can select source-A as reference.

For the frequency used to transmit NR SL communication, if the UE is out of coverage on the concerned frequency, and if UE determines or considers that it is in coverage of source-A, and if the source-A concerns the at least one of primary cell or secondary cell, the UE can select at least one of primary cell or secondary cell as reference.

For the frequency used to transmit NR SL communication, if the UE is out of coverage on the concerned frequency, and if UE determines or considers it is in coverage of source-A, and if source-A not concerns the at least one of primary cell or secondary cell, the UE can select source-A as reference.

The UE determines that it is in the coverage of source-A in response to the UE obtaining message-A scheduled by the source-A. The UE determines that it is in the coverage of source-A in response to the UE obtaining (e.g., receiving) message-A scheduled by PDCCH of the source-A. In some examples, the message scheduled by source-A or PDCCH of source-A includes the message that the UE obtains (e.g., received) from source-A directly, i.e. not via relay UE.

For the frequency used to transmit NR SL communication, if the frequency is included in the message-A scheduled by source-A, the UE can select source-A as reference.

For the frequency used to transmit NR SL communication, if the frequency concerns source-A, and if frequency is included in the message-A scheduled by source-A, the UE can select source-A as reference.

For the frequency used to transmit NR sidelink communication, if the frequency concerns the source-A, and if SIB 12 is scheduled by source-A directly, UE can select the downlink frequency paired with source-A as reference.

For the frequency used to transmit NR SL communication, in response to determining that the UE is out of coverage on the concerned frequency, and that the frequency is included in the message-A scheduled by source-A, the UE can select source-A as reference.

For the frequency used to transmit NR SL communication, in response to determining that the UE is out of coverage on the concerned frequency, and that frequency is included in the message-A scheduled by source-A, and if the frequency concern the at least one of primary cell or secondary cell, the UE can select at least one of primary cell or secondary cell scheduling SIB 12 as reference.

For the frequency used to transmit NR SL communication, in response to determining that the UE is out of coverage on the concerned frequency, that frequency is included in the message-A scheduled by source-A, and that the frequency does not concerns the at least one of primary cell or secondary cell, the UE can select frequency scheduling message-A as reference.

In the example in which the frequency is included in message-A scheduled by the source-A, a value indicating whether the UE can transmit synchronization information is set to true, and this value is included in the message-A scheduled by source-A, the UE transmits SL Synchronization/Physical Broadcast Channel (PBCH) Block SSB on the frequency used for NR SL communication. In the example in which the frequency is included in the message-A scheduled by source-A, and if the Reference Signal Received Power (RSRP) of source-A is lower that a configured threshold, the UE transmits SL SSB on the frequency used for NR SL communication. If UE is in coverage of source-A, UE transmit sidelink SSB on frequency used for NR SL communication based one the configuration scheduled by source-A.

For the UE connected to the Network via relay UE, the UE can ignore the message-A scheduled directly by source-A. For the UE connected to the Network via relay UE, the UE is not allowed to obtain the message-A scheduled by source-A directly. The UE's primary cell is the cell from which UE can obtain the message-A scheduled directly by source-A. UE's serving cell is the cell from which UE can obtain the SIB scheduled directly by network. For the UE connected to the Network via relay UE, the UE can ignore the message-A scheduled directly by source-A, in response to determining that the source-A is not the cell to which the UE is connected. For the UE connected to the Network via a relay UE, if the message-A scheduled by source-A is received, the UE considers that the message-A is not received, in response to determining that the source-A is not the cell to which the UE connected. For the UE connected to the Network via a relay UE, if the message-A scheduled by source-A is received, the UE considers that it is not in coverage of source-A, in response to determining that the source-A is not the cell to which the UE connected.

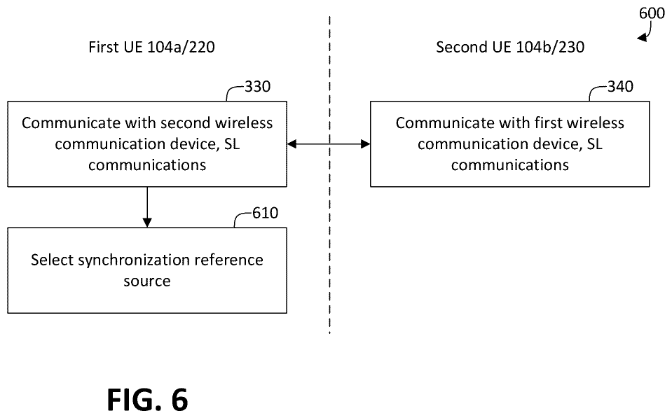

FIG. 6 is a flowchart diagram illustrating an example method 600 for managing SL wireless communications, according to various arrangements. Referring to FIGS. 1A-6, the method 600 can be performed by a first UE (e.g., the UE 104a/220) and a second UE (e.g., the UE 104b/230). Communication via the SL wireless communication channel 170 or SL network is shown as cross the dashed line between the first UE and the second UE.

At 330, as described, the first UE communicates with the second UE SL communications. At 340, as described, the second UE communicates with the first UE SL communications. At 610, the first UE selects synchronization reference source.

In some examples, the first UE selects source-A (e.g., Network 102/210) as a reference source in response to determining that the first UE is in coverage of the source-A. For example, the UE considers that it is in coverage of source-A in response to the UE obtaining message-A scheduled by the source-A.

In some examples, the first UE selects source-A as reference source for the frequency used to transmit NR SL communications in response to determining that the frequency is included in message-A scheduled by source-A.

In some examples, the first UE selects source-A as reference source for the frequency used to transmit NR SL communications in response to determining that the frequency is related to source-A, and that the frequency is included in message-A scheduled by source-A.

In some examples, the first UE selects downlink frequency paired with source-A as reference source for the frequency used to transmit NR SL communications in response to determining that the frequency is related to source-A, and that the frequency is included in message-A scheduled by source-A.

In some examples, the first UE selects source-A as reference source for the frequency used to transmit NR SL communications in response to determining that the UE is out-of-coverage on a frequency, and the frequency is included in message-A scheduled by source-A. In some examples, the first UE selects source-A scheduling the SIB12 as reference source for the frequency used to transmit NR SL communications in response to determining that the UE is out-of-coverage on a frequency, and the frequency is included in message-A scheduled by source-A.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
communicating, by a first wireless communication device with a second wireless communication device, sidelink (SL) communications; and
reporting, by the first wireless communication device to a Network, at least one frequency used in the SL communications with the second wireless communication device based on a Quality of Service (QOS) flow.

2. The wireless communication method of claim 1, wherein reporting the at least one frequency used in the SL communications with the second wireless communication device based on the QoS flow comprises reporting the at least one frequency associated with the QoS flow for each of a plurality of services of the SL communications.

3. The wireless communication method of claim 1, wherein reporting the at least one frequency used in the SL communications with the second UE based on the QoS flow comprises reporting a mapping that maps the at least one frequency to the QOS flow for each of a plurality of services of the SL communications.

4. The wireless communication method of claim 1, further comprises passing the at least one frequency from a higher layer to a lower layer, wherein the SL communications is performed for the QoS flow in the lower layer using the at least one frequency.

5. A first wireless communication device, comprising:
at least one processor configured to:
communicate, via a transceiver with a second wireless communication device, sidelink (SL) communications; and
report, via the transceiver to a Network, at least one frequency used in the SL communications with the second wireless communication device based on a Quality of Service (QoS) flow.

6. The first wireless communication device of claim 1, wherein to report the at least one frequency used in the SL communications with the second wireless communication device based on the QoS flow comprises to report at least one frequency associated with the QoS flow for each of a plurality of services of the SL communications.

7. The first wireless communication device of claim 1, wherein to report the at least one frequency used in the SL communications with the second UE based on the QoS flow comprises to report a mapping that maps the at least one frequency to the QoS flow for each of a plurality of services of the SL communications.

8. The first wireless communication device of claim 1, wherein the at least one processor is configured to pass the at least one frequency from a higher layer to a lower layer, wherein the SL communications is performed for the QoS flow in the lower layer using the at least one frequency.

9. A wireless communication method, comprising:
receiving, by a Network from a first wireless communication device to, a report comprising at least one frequency used in the SL communications with the second wireless communication device based on a Quality of Service (QOS) flow,
wherein the first wireless communication device communicates with a second wireless communication device via sidelink (SL) communications.

10. The wireless communication method of claim 9, wherein the report comprising the at least one frequency used in the SL communications with the second wireless communication device based on the QoS flow, comprises at least one frequency associated with the QoS flow for each of a plurality of services of the SL communications.

11. The wireless communication method of claim 9, wherein the report comprising the at least one frequency used in the SL communications with the second UE based on the QoS flow, comprises a mapping that maps the at least one frequency to the QoS flow for each of a plurality of services of the SL communications.

12. The wireless communication method of claim 9, wherein the at least one frequency passes from a higher layer to a lower layer, wherein the SL communications is performed for the QoS flow in the lower layer using the at least one frequency.

13. A network node, comprising:
at least one processor configured to:
receive, via a receiver from a first wireless communication device to, a report comprising at least one frequency used in the SL communications with the second wireless communication device based on a Quality of Service (QOS) flow,
wherein the first wireless communication device communicates with a second wireless communication device via sidelink (SL) communications.

14. The network node of claim 13, wherein the report comprising the at least one frequency used in the SL communications with the second wireless communication device based on the QoS flow, comprises at least one frequency associated with the QOS flow for each of a plurality of services of the SL communications.

15. The network node of claim 13, wherein the report comprising the at least one frequency used in the SL communications with the second UE based on the QoS flow, comprises a mapping that maps the at least one frequency to the QoS flow for each of a plurality of services of the SL communications.

16. The network node of claim 13, wherein the at least one frequency is passed from a higher layer to a lower layer, wherein the SL communications is performed for the QoS flow in the lower layer using the at least one frequency.
